(19) United States
(12) Patent Application Publication
(10) Pub. No.: US 2026/0257617 A1
(43) Pub. Date: Sep. 3, 2026

(54) ILLUMINATION SYSTEM AND METHOD FOR A VEHICLE

(71) Applicant: NISSAN NORTH AMERICA, INC., Franklin, TN (US)

(72) Inventors: Preet RANA, Canton, MI (US); Nelson S. PHAN, Rochester Hills, MI (US)

(21) Appl. No.: 19/068,061

(22) Filed: Mar. 3, 2025

(51) Int. Cl. B60Q 3/30; B60R 16/03; B62D 43/10

(52) U.S. Cl. CPC B60Q 3/30; B60R 16/03; B62D 43/10

(57) ABSTRACT

An illumination system for a vehicle includes a plate member and an illumination device. The plate member is positioned in the vehicle, the plate member including a surface facing in a longitudinal direction of the vehicle. The illumination device is disposed in the surface of the plate member. The illumination device emits light in the longitudinal direction and in a downward direction to illuminate a storage section of the vehicle.

### BACKGROUND

### Technical Field

The present disclosure generally relates to an illumination system and method for a vehicle. More specifically, the present disclosure relates to an illumination system disposed in storage area of a vehicle to emit light in a longitudinal direction and in a downward direction and a method of illuminating the storage area of the vehicle.

### Background Information

Conventional vehicle trunks are often equipped with lighting sources that generate illumination to provide customers with ease of using the vehicle trunk in the dark or at certain occasions when lighting is not sufficient. Many conventional light sources in vehicle trunks are dome light sources.

### SUMMARY

It has been discovered that these conventional lighting system can be inadequate for lighting spare tire holding area of the vehicle. As can be understood, with dome lighting system and other conventional lighting systems, no light is dispersed onto the spare tire, or into the spare tire area or other areas when the a cover panel or carpet to access a spare tire or other area is moved into the open position. It has been determined that upward facing lights make it difficult to see cargo area as well. In some conventional systems, is can be difficult for the eyes to adjust from upward light to see the spare tire area.

In view of the state of the known technology, one aspect of the present disclosure is to provide an illumination system for a vehicle comprising a plate member and an illumination device. The plate member is configured to be positioned in the vehicle. The plate member includes a surface facing in a longitudinal direction of the vehicle. The illumination device is disposed in the surface of the plate member. The illumination device is configured to emit light in the longitudinal direction and in a downward direction to illuminate a storage area of the vehicle.

Another aspect of the present disclosure is to provide a method of illuminating an area of a vehicle area, comprising disposing an illumination device in a surface of a plate member in a rear section of the vehicle, operating a switch to turn on the illumination device, opening an access panel in the vehicle to access a storage area, and illuminating the storage area with the illumination device by emitting light in a forward direction and in a downward direction of the vehicle.

Also, other objects, features, aspects and advantages of the disclosed suspension frame cover system will become apparent to those skilled in the art from the following detailed description, which, taken in conjunction with the annexed drawings, discloses preferred embodiments of the suspension frame cover system.

### BRIEF DESCRIPTION OF THE DRAWINGS

Referring now to the attached drawings which form a part of this original disclosure, an illustrative embodiment is shown.

FIG. 1 is a partial cross sectional view of a vehicle including the illumination system according to one embodiment of the present disclosure;

FIG. 2 is a top plan view of the rear portion of the vehicle including the illumination system of FIG. 1;

FIG. 3 is an enlarged partial cross sectional view of the vehicle including the illumination system of FIG. 1 with the spare tire holding area panel in an open configuration;

FIG. 4 is a cross section of view of the plate member in an installed position;

FIG. 5 is a top plan view of the plate member;

FIG. 6 is a front elevational view of the plate member;

FIG. 7 is a cross section of view of the plate member taken along line 7-7 in FIG. 5;

FIG. 8 is a cross section of view of the plate member taken along line 8-8 in FIG. 5;

FIG. 9 is a bottom view of the plate member;

FIG. 10 is a perspective view of the plate member;

FIG. 11 is a perspective view of the illumination device disposed in a portion of the plate member; and

FIG. 12 is a perspective view of the illumination device.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment and should not be interpreted as defining or limiting the range of values or properties encompassed by illustrative embodiments unless specified.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

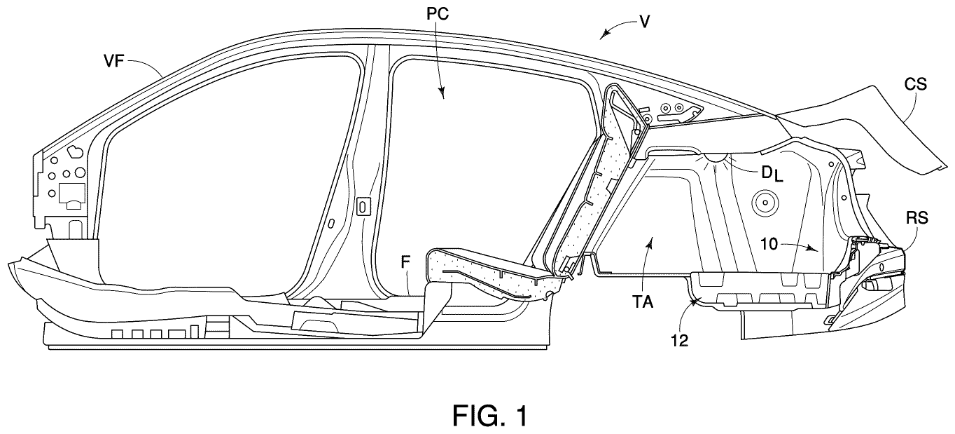

Referring initially to FIGS. 1-4, an illumination system 10 in a vehicle V is illustrated in accordance with a first embodiment. The illumination system 10 can be disposed in the vehicle V and can illuminate a storage area 12 of the vehicle V.

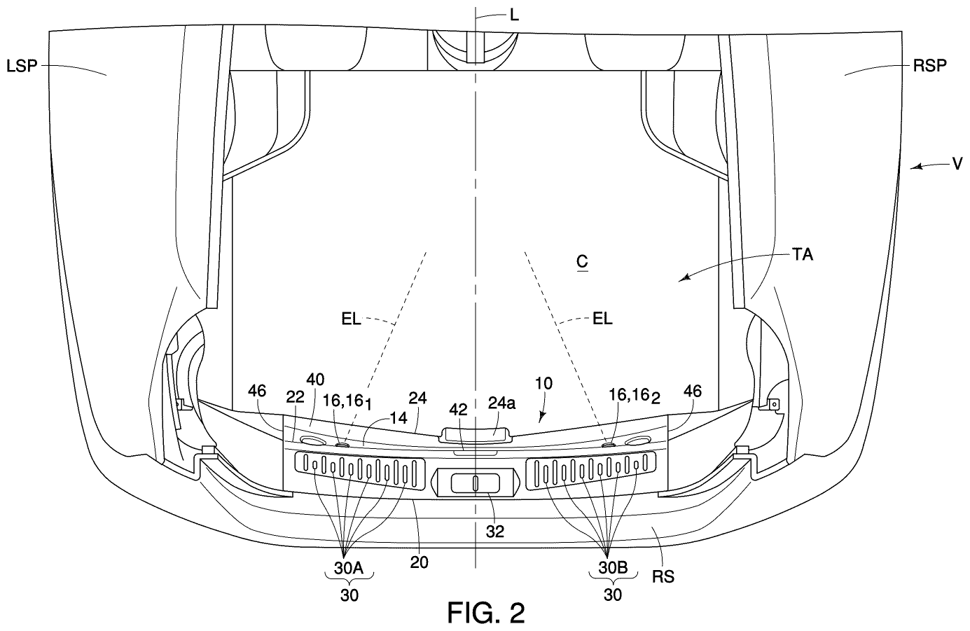

In one embodiment, the illumination system 10 includes a plate member 14 and an illumination device 16. As shown in FIGS. 1 and 2, the illumination system 10 is disposed in the vehicle V. In this embodiment, the illumination system 10 is disposed on a rear structure RS in the trunk of the vehicle V. That is, the vehicle V can have a passenger compartment PC and a trunk area TA. In this embodiment, the trunk area TA is in the rear of the vehicle V and behind the passenger compartment PC. However, as can be understood, the illumination device 16 can be disposed in any suitable portion of the vehicle V in which storage is desired, and is not necessarily disposed in the trunk area TA of the vehicle V. For example, some vehicles include a frunk (or a front trunk). These frunks are common in electric vehicles. Other vehicles can include storage areas in floor F of the passenger compartment PC or in any other suitable area to store vehicle related elements or any other suitable elements. Accordingly, the illumination device 16 can be disposed in a trunk, a frunk, in a floor or in any desired area of a vehicle V.

Moreover, while the vehicle V is illustrated as a sedan, the vehicle V can be any suitable vehicle in which such illumination system 10 is desired.

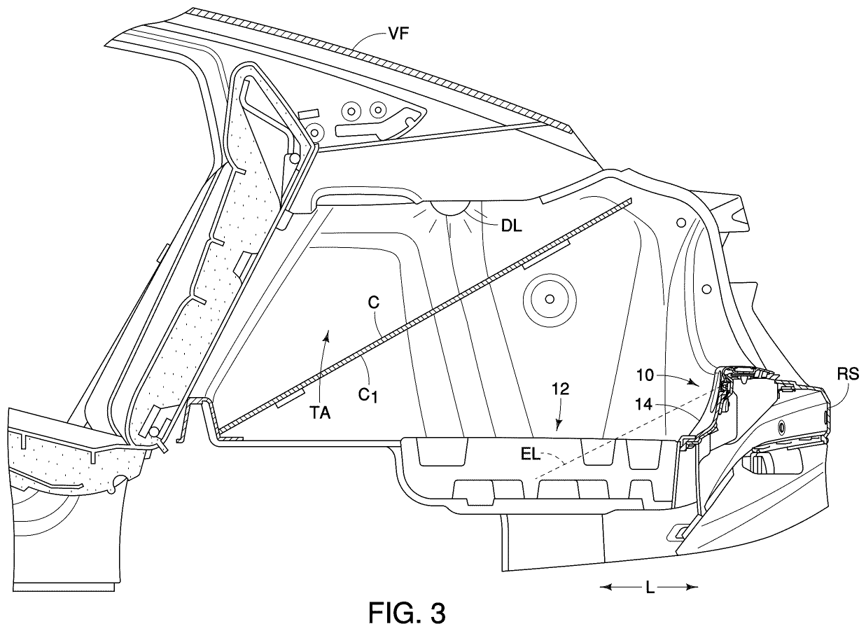

As illustrated in FIGS. 1-4, the vehicle V includes a vehicle frame VF, a trunk area TA, a storage area 12, a trunk closing structure CS (for example a trunk lid), a storage area 12 and a cover C (one embodiment of an access panel) for the storage area 12. In one embodiment the storage area 12 can be a spare tire holding area. That is, in some vehicles, the spare tire holding area is disposed beneath a cover C in the trunk area TA of a vehicle. As can be understood, in some vehicles, the trunk dome light DL (or other trunk area lighting system) is insufficient to provide lighting into the spare tire holding area (storage area 12). For example, when the cover C is deployed from a closed position to an open position, the cover can block the doom light. In this case, it can be difficult to see objects in the spare tire holding area (storage area 12). See for example, FIG. 3. Accordingly, the illumination system is disposed to provide the spare tire holding area (storage area 12) with improved lighting.

The vehicle frame VF includes the rear structure RS that is configured to couple to the trunk closing structure CS to close the trunk area TA. The rear structure RS is disposed at the bottom and the rear of the trunk area TA and extends along the width of the trunk opening TO. As illustrated in FIG. 2, the opening TO to the trunk area TA is generally defined by the rear structure RS and the left and right side panels LSP and RSP of the vehicle V.

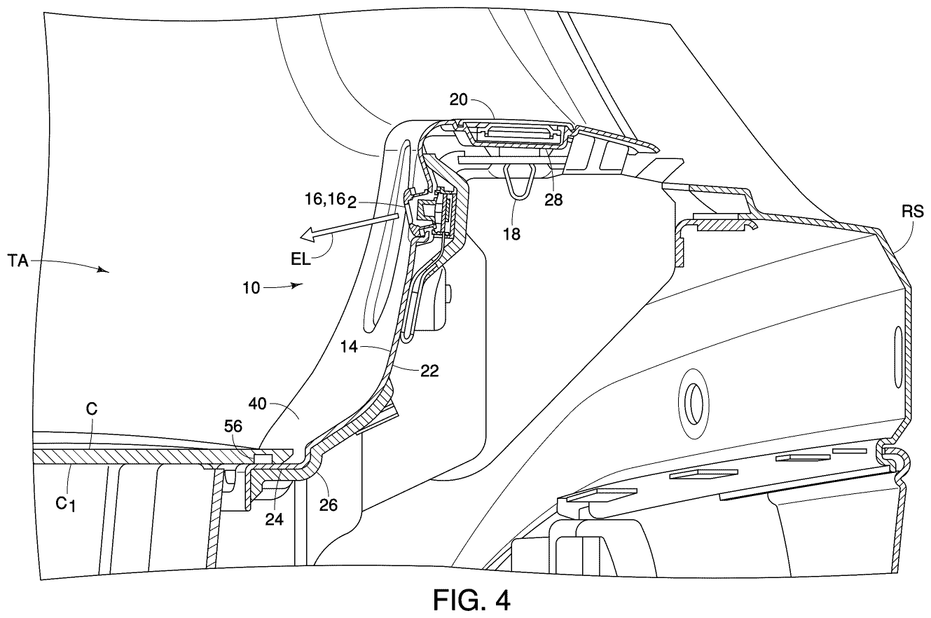

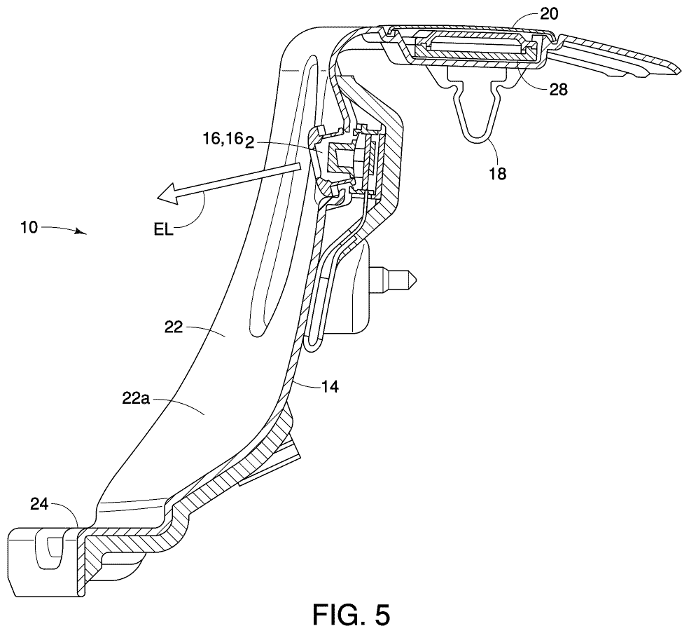

The plate member 14 is configured to be positioned in the vehicle and couple to the rear structure RS and overlie at least a portion of the rear structure RS. In one embodiment, the plate member is configured to be disposed in a trunk area of the vehicle. The plate member 14 can be a plastic molded structure that is attached to the rear structure RS. As shown in FIG. 5, the plate member 14 includes a plurality of fittings 18 that enable the plate member 14 to be affixed to the rear structure RS. As shown in FIGS. 4 and 5, the plate member 14 includes an upper section 20, a middle section 22 and a lower section 24. The middle section 22 is configured to extend generally in an upward and downward direction and transverse to the longitudinal axis L of the vehicle V. The upper section 20 extends generally perpendicular to the middle section 22 and in a rear direction along the longitudinal axis L of the vehicle V. The lower section 24 extends in a forward direction from the middle section 22 and is configured to couple to the floor 26 of the trunk area TA.

The upper section 20 includes the plurality of fittings 18 extending from the bottom surface 28 thereof. Fittings 18 can be any suitable fitting that enable a secure connection of the plate member 14 to the rear section RS. The upper section 20 can include a plurality of lights 30 disposed thereon. The plurality of lights 30 can number any number desired. The plurality of lights 30 includes a first plurality of lights 30A and a second plurality of lights 30B. The first and second plurality of lights 30A and 30B are disposed on either side of the latch mechanism 32 for the closing structure CS. In this embodiment each of the first and second plurality of lights 30A and 30B includes thirteen lights of varying length. The plurality lights 30 are disposed to emit light in the trunk area TA to improve use of the trunk area TA in low light environments.

The upper section 20 includes an opening 34 and a depression 36 for the latch mechanism 32 for the closing structure CS. This mechanism 32 can be a conventional mechanism and therefore further description thereof is not necessary. It is noted that the upper section 20 can include a switching mechanism 38 that activates the plurality of lights 30 when the switching mechanism 38 is activated and the closing structure CS is opened. For example, the switching mechanism 38 can be a switch that is operated when the closing structure is separated from the plate member 14. The switching mechanism 38 can also extinguish the plurality of lights 30 when the closing structure CS is moved into the closed position. The switching mechanism 38 can be disposed in any suitable place and operate in any suitable manner and is not necessarily connected to the upper section 20.

The lower section 24 is generally parallel to the floor 26 of the trunk area TA and is configured to be attached thereto. The lower section 24 can have any suitable configuration that enables a smooth transition from the middle section 22 to the floor 26 of the trunk area TA. The lower section 24 can include a recessed area 24a. The recessed area enables improved access to the lower surface C1 of the cover C. That is, the recessed area 24a enables a user to place a hand under the cover C to lift the cover C from the closed position to the open position.

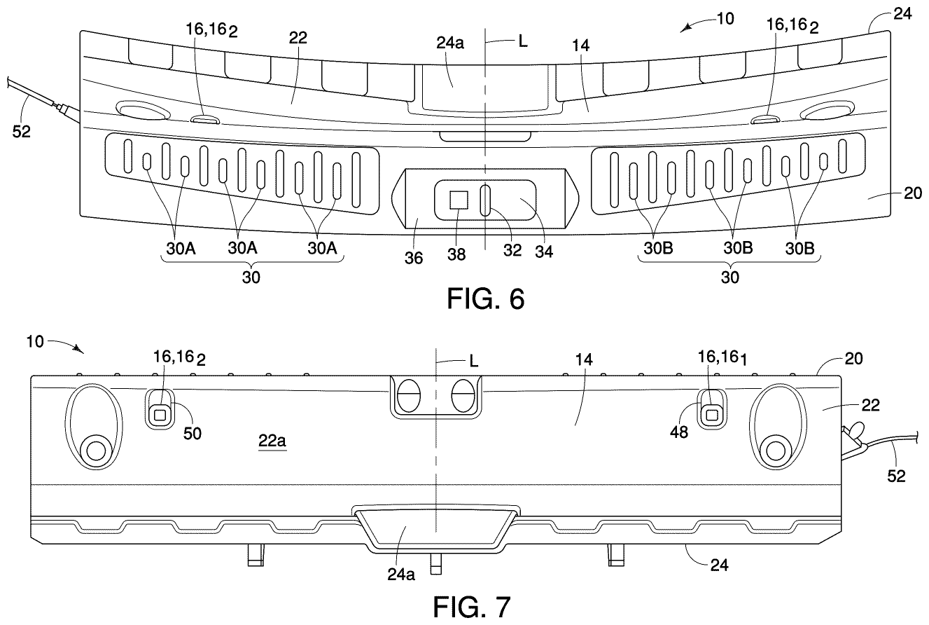

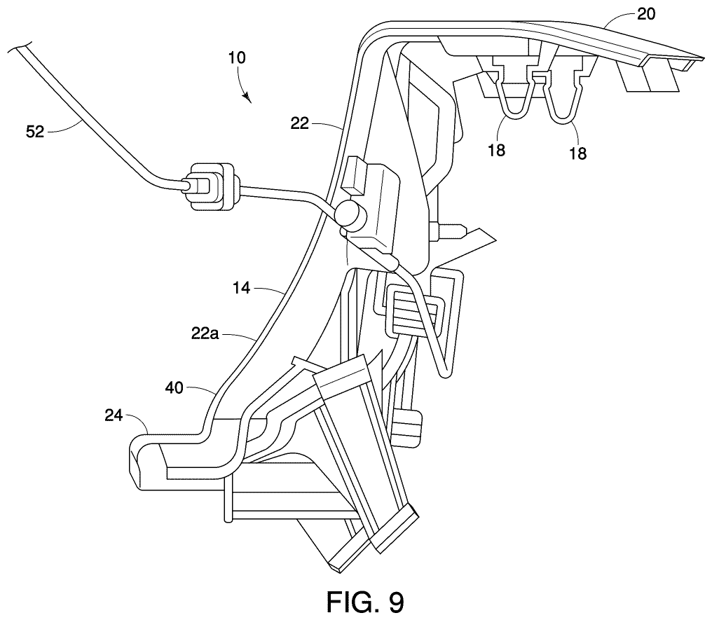

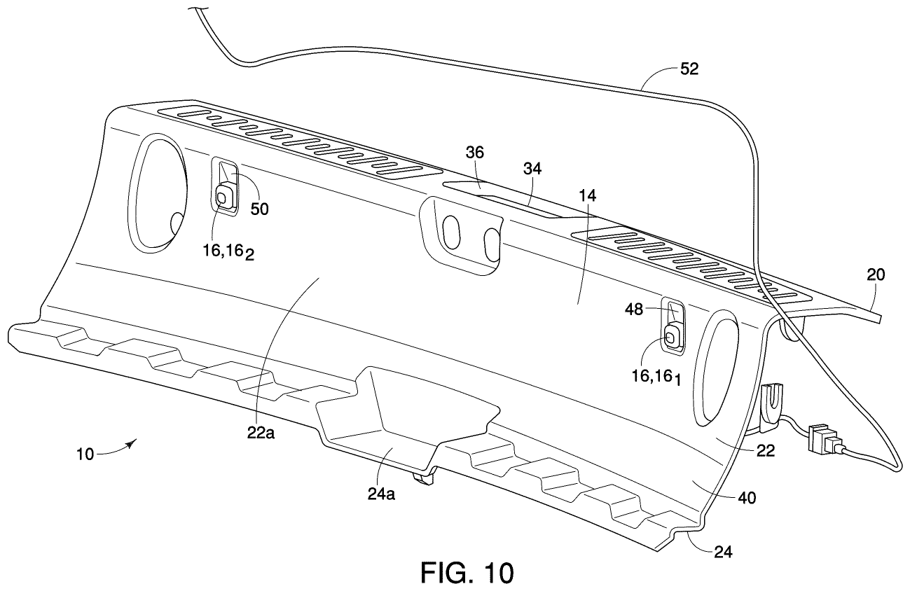

As illustrated in FIGS. 5-10, the middle section 22 is disposed between the upper section 20 and the lower section 24. The middle section 22 generally extends perpendicularly from the upper section 20 and slopes in a forward direction relative to the upper section 20. The middle section includes a surface 20a facing in a longitudinal direction of the vehicle middle section 22 extends generally transverse or perpendicular to the longitudinal axis L of the vehicle V. As illustrated in FIGS. 2 and 6 the middle section 22, at least at the lower portion 40 thereof, can have a curved configuration. In other words, in this embodiment the lower portion 40 of the middle section 22 curves in a forward direction of the vehicle V from the center portion 42 to the end portions 44 and 46.

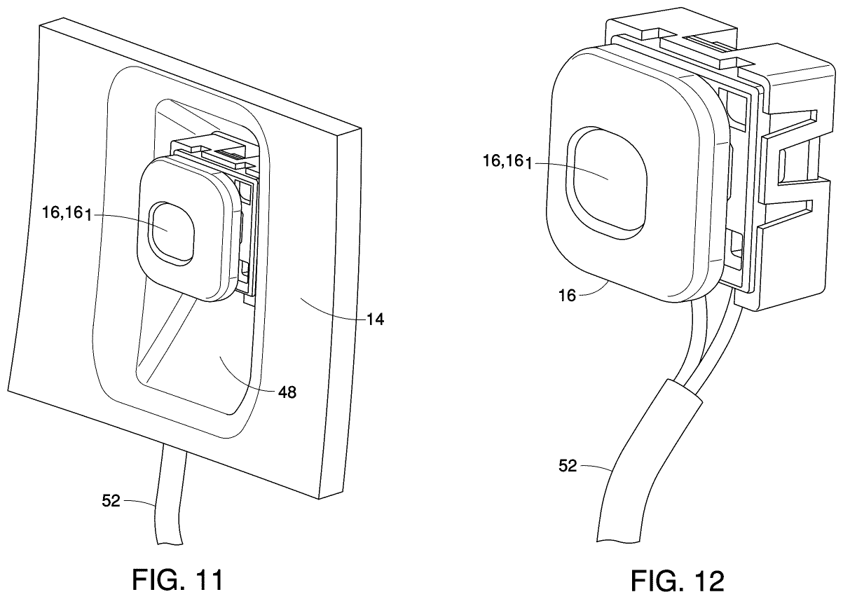

The middle section 22 includes the illumination device 16. The illumination device 16 is disposed in the surface 22a of the plate member 14, and configured to emit light EL in the longitudinal direction and in a downward direction to illuminate a storage section 12 of the vehicle V. In this embodiment, the illumination device 16 includes a first illumination device 16₁ and a second illumination device 16₂. The first and second illumination devices 16₁ and 16₂ are closer to the upper section 20 than the lower section 24. For example, the first and second illumination devices 16₁ and 16₂ can be disposed generally adjacent the upper section 20. In one embodiment, the first and second illumination devices 16₁ and 16₂ are configured to be disposed at a same height above a floor 26 of a truck area TA (e.g., a rear section) of the vehicle V. The first and second illumination devices 16₁ and 16₂ can be disposed on either side of a center portion 42 of the middle section 22 and can be disposed within first and second recessed portions 48 and 50 of the middle section 22 (see for example, FIGS. 11 and 12). In one embodiment the first and second illumination devices 16₁ and 16₂ are disposed an a downward and inward angle to emit light EL in the general direction of the floor 26 of the trunk area TA. In the embodiment illustrated, the first and second illumination devices 16₁ and 16₂ are disposed to emit light EL in a forward direction of the vehicle V from the sear structure RS and toward the central area of the trunk area TA. See for example, FIG. 2.

The curved configuration of middle section 22 can enable the first and second illumination devices 16₁ and 16₂ to emit light EL in an inward direction relatively the outboard sides of the vehicle V. Alternatively or in addition to this configuration, the first and second illumination devices 16₁ and 16₂ can be movable or positionable to emit light EL in an inward direction. In one embodiment, the first and second illumination devices 16₁ and 16₂ are disposed so as to emit light EL at downward angle and inward angle, such that a maximum amount of light is emitted at about the central portion of the storage area 12.

In one embodiment the distance from the center line of the middle section 22 and each of the first and second illumination devices 16₁ and 16₂ is approximately between about 500 mm and 600 mm (e.g., 552 mm). The distance between center line of the first and second illumination devices 16₁ and 16₂ to the spare tire cover is approximately between about 90 and 110 mm (e.g., 103 mm), and the distance between trunk opening TO is approximately between about 1050-1150 mm (e.g., 1105 mm). The first and second illumination devices 16₁ and 16₂ can be positioned to illuminate generally perpendicularly from the middle section 22. However, in one embodiment, the first and second illumination devices 16₁ and 16₂ can be disposed to emit light EL in a downward direction. Preferably the first and second illumination devices 16₁ and 16₂ are configured to emit light EL at an angle of about 15-46 degrees relative to the middle section 22 from about 100-150 mm above the floor 36 of the trunk area TA. By emitting light in a downward direction, the first and second illumination devices 16₁ and 16₂ are disposed to improve the illumination of the floor 28 of the trunk area TA and into the spare tire holding area (storage area 12).

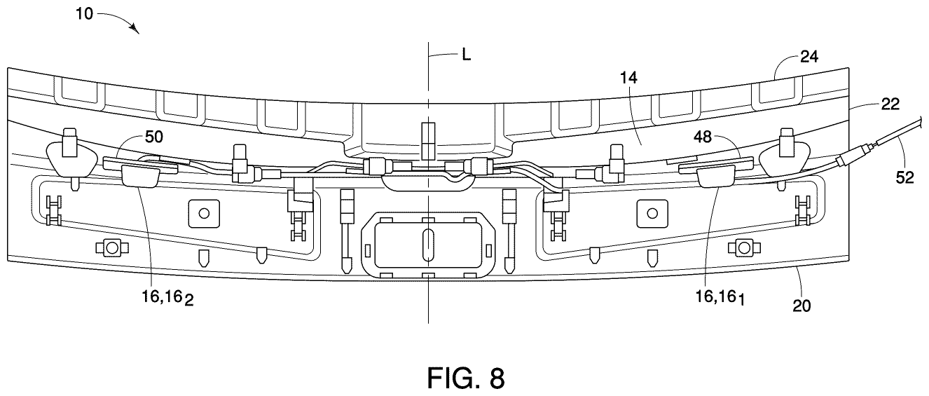

As illustrated in FIGS. 8-10, the first and second illumination devices 16₁ and 16₂ are electrically wired to receive power from the electrical system of the vehicle V. That is, a wire transmits electrical power to each of the first and second illumination devices 16₁ and 16₂. In one embodiment, the same electrical wiring harness 52. Moreover, the same electrical wiring harness 52 can provide electrical power to the first and second illumination devices 16₁ and 16₂ and the plurality of lights 30. Such a wiring system improves the wiring aspects of the illumination system 10 and reduces the possibility of electrical failure.

In one embodiment, the illumination system 10 is operated on the same switching mechanism 38 as the plurality of lights 30. That is, operating the closing structure CS, the illumination system 10 will turn on, and will emit light. In another embodiment, the illumination system 10 can be operated by a separate switch (e.g., switch 56). The switch 56 can be operated when the trunk closing structure CS is operated (i.e., opened) or when the cover C to the storage area 12 is operated (i.e., opened). The switch 56 can be any suitable switch that detects or determines when the cover C is operated or when the operation of the illumination system 10 may be desired. In this embodiment, the illumination device 16 will remain in the off configuration, even when the closing structure CS is operated to the open position. The illumination device 16 will remain in the off configuration until the cover C for the storage area 12 is operated or opened.

To operate the illumination system 10, an illumination device 16 is disposed in a surface of a plate member 14 in a rear section of the vehicle V. An operation switch (e.g., switch 56) if operated turns on the illumination device 16. An access panel (cover C) in the vehicle V is opened to access a storage area 12, and the illumination device 16 illuminates the storage area 12 by emitting light in a forward direction and in a downward direction of the vehicle V.

As can be understood, sine the illumination device 16 is directed in a downward direction along the longitudinal axis L of the vehicle, when the cover C is disposed in the open position, the illumination device 16 will emit light EL into the storage area 12. Such illumination of the storage area 12 occurs even when the cover C is blocking the light from the dome light DL. Thus, the illumination 16 of the present disclosure emits light to the storage area 12 of the vehicle V while an access panel (e.g., cover C) of the vehicle V is disposed in an open position enabling access to the storage area 12, which improves the visibility and the use of the trunk area Ta and the storage area 12 of a vehicle.

The closing structure CS, the dome light DL and the switching mechanism 38 are conventional components that are well known in the art. Since closing structure CS, the dome light DL and the switching mechanism 38 are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the illumination system for a vehicle. Accordingly, these terms, as utilized to describe the present invention should be interpreted relative to a vehicle equipped with the illumination system for a vehicle.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. An illumination system for a vehicle, comprising:
a plate member configured to be positioned in the vehicle, the plate member including a first surface facing in a longitudinal direction of the vehicle and an upper surface facing in a horizontal direction;
an illumination device to be disposed in the first surface of the plate member at a predetermined angle in a downward direction, the illumination device configured to emit light in the longitudinal direction and in the downward direction to illuminate a storage section of the vehicle; and
a switching mechanism disposed at the upper surface of plate member, the switching mechanism configured to cause the illumination device to emit the light when a closing structure is lifted from the upper surface of the plate member.

2. The illumination system according to claim 1, wherein
the plate member is configured to be disposed in a trunk area of the vehicle.

3. The illumination system according to claim 1, wherein
the storage section of the vehicle is a spare tire holding area of the vehicle.

4. The illumination system according to claim 1, wherein
the illumination device is a first illumination device and the illumination system includes a second illumination device.

5. The illumination system according to claim 4, wherein
the first and second illumination devices are configured to be disposed at a same height above a floor of a rear section of the vehicle.

6. The illumination system according to claim 4, wherein
the first and second illumination devices are configured to be disposed between about 500 mm and 600 mm from each other.

7. An illumination system for a vehicle, comprising:
a plate member configured to be positioned in the vehicle, the plate member including a first surface facing in a longitudinal direction of the vehicle and a top surface facing in a horizontal direction;
an illumination device to be disposed in the first surface of the plate member, the illumination device configured to emit light in the longitudinal direction and in a downward direction to illuminate a storage section of the vehicle; and
a plurality of lights disposed on the top surface of the plate member.

8. The illumination system according to claim 7, wherein
the plurality of lights and the illumination device are configured to receive power from a same wiring harness.

9. The illumination system according to claim 1, wherein
the illumination device is configured to emit light to the storage area of the vehicle while an access panel of the vehicle is disposed in an open position enabling access to the storage area.

10. A method of illuminating an area of a vehicle area, comprising:
disposing an illumination device in a first surface of a plate member at a predetermined angle in a downward direction in a rear section of the vehicle;
disposing a switch at a bottom surface of the plate member that faces in a horizontal direction to turn on the illumination device when an access panel is opened from a closed configuration to an open configuration, the bottom surface configured to support the access panel in the closed configuration;
opening the access panel in the vehicle to access a storage area; and
illuminating the storage area with the illumination device by emitting light in a forward direction and in a downward direction of the vehicle.

11. The method according to claim 10, wherein
the disposing an illumination device in the first surface of the plate member in the rear section of the vehicle includes disposing the illumination device in a trunk of the vehicle.

12. The method according to claim 10, wherein
the illumination device is a first illumination device and the method includes disposing a second illumination device in the first surface of the plate member in the rear section of the vehicle.

13. The method according to claim 12, wherein
the first and second illumination devices are disposed at a same height above a floor of the rear section of the vehicle.

14. The method according to claim 12, wherein
the first and second illumination devices are configured to be disposed between about 500 mm and 600 mm from each other.

15. The method according to claim 10, further comprising
disposing a plurality of lights on the upper surface of the plate member.

16. The method according to claim 15, wherein
the plurality of lights and the illumination device are configured to receive power from a same wiring harness.

17. (canceled)

18. The illumination system according to claim 1, wherein the illumination device is configured to emit the light at an angle of about 15-46 degrees relative to the longitudinal direction of the vehicle.

19. The method according to claim 10, wherein
the illumination device is configured to emit the light at an angle of about 15-46 degrees relative to the longitudinal direction of the vehicle.

20. The method according to claim 10, wherein
the switch is disposed beneath the access panel when the access panel is in the closed configuration.

21. The illumination system according to claim 1, wherein
the closing structure is a trunk closing structure.
